(19) United States
(12) Patent Application Publication
(10) Pub. No.: US 2022/0018328 A1
(43) Pub. Date: Jan. 20, 2022

(54) ROTOR BLADE OF A WIND TURBINE, COMPRISING AN INSULATOR LAYER AND A PROTECTIVE LAYER

(71) Applicant: SIEMENS GAMESA RENEWABLE ENERGY SERVICE GMBH, Hamburg (DE)

(72) Inventor: Urs Bendel, Fockbek (DE)

(21) Appl. No.: 17/295,123

(22) PCT Filed: Nov. 18, 2019
(86) PCT No.: PCT/EP2019/081682

§ 371 Date: May 19, 2021

(30) Foreign Application Priority Data
Nov. 19, 2018 (DE) 10 2018 009 039.7

(51) Int. Cl. F03D 1/06; F03D 80/30

(52) U.S. Cl. CPC F03D 1/0675; F05B 2280/6003; F05B 2280/2006; F03D 80/30

(57) ABSTRACT

The invention relates to a rotor blade of a wind turbine, comprising at least one girder (2), at least one protective layer (4) which is arranged on the at least one girder (2) on the rotor blade outer side, wherein the at least one protective layer (4) is designed to be electrically conductive and connected to a lightning conductor (16), wherein at least one electrically insulating insulator layer (3) which is arranged between the at least one protective layer (4) and the at least one girder (2).

The invention relates to a rotor blade of a wind turbine, comprising at least one girder, at least one protective layer which is arranged on the at least one girder on the rotor blade outer side, wherein the at least one protective layer is designed to be electrically conductive and is connected to a lightning conductor. The invention also relates to a method for producing a rotor blade of a wind turbine, in which a protective layer which is designed to be electrically conductive is arranged on at least one girder on the rotor blade outer side and is connected to a lightning conductor.

Rotor blades with girders are already well known in the prior art. Basically, rotor blades can consist of a rotor blade shell which in turn is advantageously made from two rotor blade half-shells. A girder extends in the longitudinal direction of each of the rotor blade half-shells. The two girders are situated opposite one another, and a web runs along between the girders. A plurality of girders can be provided for each rotor blade half-shell, and likewise a plurality of webs can be provided.

One problem with rotor blades is that lightning strikes impact in the tip region of the rotor blade and along the rotor blade trailing edge. For conducting the lightning strikes away, lightning receptors are provided which are therefore arranged in particular at the tip and along the rotor blade trailing edge. The lightning receptors are connected to a lightning conductor which is earthed so that the lightning strike is conducted through the rotor blade and the tower and away into the earth.

Due to the increasing rotor diameter, carbon fibres are increasingly built into the rotor blades. In particular, the girders can also have fibre-containing layers, and the girders can even be made substantially from materials containing carbon fibres. The CFRP girders are electrically conductive and attract lightning strikes. In order to protect the CFRP girders, can the CFRP girders can be covered with an electrically conductive protective layer on the rotor blade outer side.

The protective layer can be a film, a woven fabric, laid fabric or warp knitted fabric or the like, made from an electrically conductive material, preferably copper, aluminium or carbon fibres, and the protective layer is electrically conductively connected to the lightning conductor in a known manner. Such a lightning conductor system is described for example in EP 3 330 528 A1.

Here it has been shown that in the event of lightning strikes damage can nevertheless occur on the girders.

It is an object of the present invention to provide a rotor blade of a wind turbine which offers better protection against lightning strikes by comparison with the prior art.

It is also an object of the present invention to provide a method for producing such a rotor blade.

With regard to the rotor blade, this object is achieved by a rotor blade referred to in the introduction and having the features of claim 1.

Surprisingly, it has been shown that the at least one electrically conductive protective layer, which is preferably made from aluminium, copper or from materials containing carbon fibres, does protect the at least one girder against lightning strikes which at the strong currents occurring during the lightning strike can nevertheless damage the at least one girder.

The invention therefore provides for the at least one protective layer to be electrically conductively decoupled from the at least one girder. For this purpose, according to the invention between the at least one girder and the at least one protective layer at least one electrically insulating insulator layer is provided which is arranged between the at least one protective layer and the at least one girder. The at least one insulator layer is advantageously selected to be so great that it completely covers an outline or a contour of the at least one girder at least in the portion in which the at least one protective layer is provided, and thus electrically insulates the at least one protective layer from the at least one girder.

The at least one insulator therefore advantageously has a width which is greater in every cross-section along a longitudinal direction than the width of the at least one girder, and the at least one protective layer has a width which is likewise greater in every cross-section along the longitudinal direction than the width of the at least one girder.

The at least one insulator layer can be wider than the at least one protective layer, but it can also be narrower than the at least one protective layer.

In the tip portion the at least one protective layer projects beyond the at least one girder in the longitudinal direction, and the at least one insulator layer likewise projects beyond the at least one girder in the longitudinal direction, so that the at least one girder in its outline or in its contour is completely covered by the at least one insulator layer in the portion in which the at least one protective layer likewise covers the at least one girder. It has been shown that the electrical decoupling of the at least one girder from the at least one protective layer reduces damage to the at least one girder in the event of lightning strikes.

The CFRP girder is electrically conductive. It consists of carbon fibres surrounded by a matrix which is cured in the manufacturing process. The carbon fibres can be introduced into the girder in different forms, for example as dry layers, as pre-impregnated layers, so-called prepregs, as direct rovings or as prefabricated, already cured semi-finished products. This girder can be built up directly in the mould for the construction of the rotor blade shell, or in a separate mould, wherein the prefabricated girder is then integrated during the construction of the rotor blade shell. The so-called CFRP girders have the advantage that they are particularly light in relation to the strength and rigidity.

It is particularly preferable to provide an electrically conductive connection between the at least one girder and the at least one protective layer; although the at least one girder and the at least one protective layer are electrically insulated or decoupled from one another, in the present case this only means that over the entire extent of the at least one girder and the at least one protective layer the at least one insulator layer is provided between the two layers, which prevents a flashover or a current discharge in the event of a lightning strike. Nevertheless, it is provided that the at least one girder is to be electrically conductively connected at individual points to the at least one protective layer in order to produce a potential equalisation. In particular the at least one protective layer is electrically conductively connected to the lightning conductor, so that the lightning which strikes in the at least one protective layer is discharged into the earth. However, it can occur that the girders themselves are electrically charged by friction or also by lightning strike. In order to create a potential equalisation here, the at least one girder is electrically conductively connected to the at least one protective layer, which in turn is electrically conductively connected to the lightning conductor.

The at least one girder can have a large number of carbon fibre-reinforced individual layers, and experience has shown that such a girder can be regarded as a component which is conductive in its entirety, although the individual carbon fibres are surrounded by a plastics matrix which itself is electrically non-conductive.

The rotor blade according to the invention is characterised in that the protective layer is either not electrically conductively connected to the girder at all or is connected only by the end faces of the layers which form the girder and in fact either only at the tip end or at the root end thereof. In this case the protective layer itself is electrically conductively connected at its root end to the conductor system and is earthed thereby. The lightning conductor can be designed as an individual electrically conductive cable.

With regard to the method the object of the invention is achieved by an above-mentioned method with the characterising features of claim 8.

The said methods are suitable for the production of one of the above-mentioned rotor blades, and conversely each of the above-mentioned rotor blades can be produced by one of the said methods.

For the production of a rotor blade of a wind turbine, in which at least one protective layer which is designed to be electrically conductive is arranged on at least one girder on the rotor blade outer side and is connected to a lightning conductor. According to the invention at least one electrically insulating insulator layer is arranged between the at least one protective layer and the at least one girder. It has been shown that the electrical decoupling leads to protection of the girder in the event of lightning strikes. First of all the protective layer can be placed into a production mould for a rotor blade shell or part-shell or half-shell, the insulator layer is laid above this, and the girder is laid onto the insulator layer. Finally the structure can be laminated. CFRP girders are preferably used for the girder.

An electrically conductive connection is preferably formed between the at least one girder and the at least one protective layer only at the tip end of the girder or only at the root end of the girder. The production process provides particular savings on material.

The at least one girder advantageously has a large number of carbon fibre-reinforced individual layers.

The invention is described with reference to three exemplary embodiments in four drawings. In the drawings:

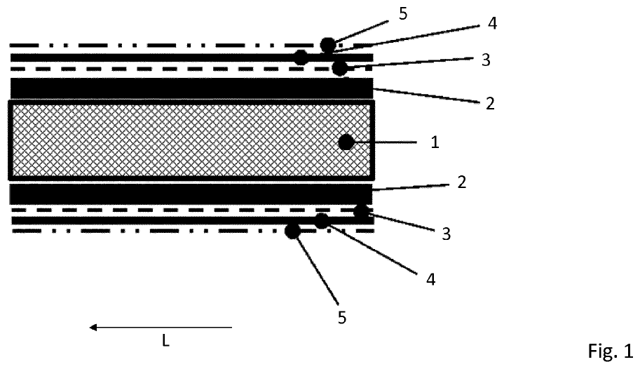

FIG. 1 shows a sectional view of a longitudinal section of a rotor blade according to the invention along a web,

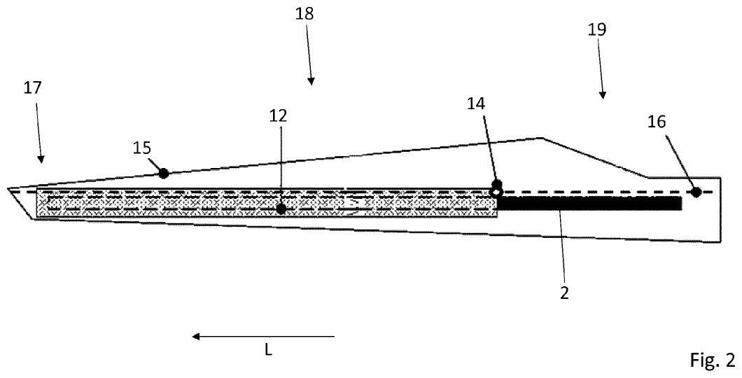

FIG. 2 shows a top view of the rotor blade according to the invention with a CFRP girder and a protective layer according to the invention which is completely insulated relative to the CFRP girder,

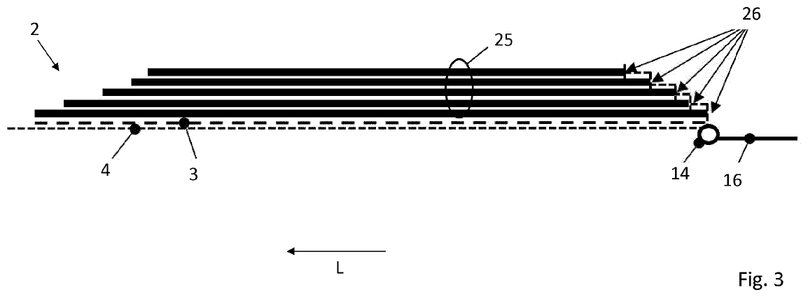

FIG. 3 shows a view of a basic construction of the longitudinal section of the CFRP girder having the protective layer and an insulator in a second embodiment, wherein the protective layer is electrically conductively connected to the end faces of the CFRP layers at the root end,

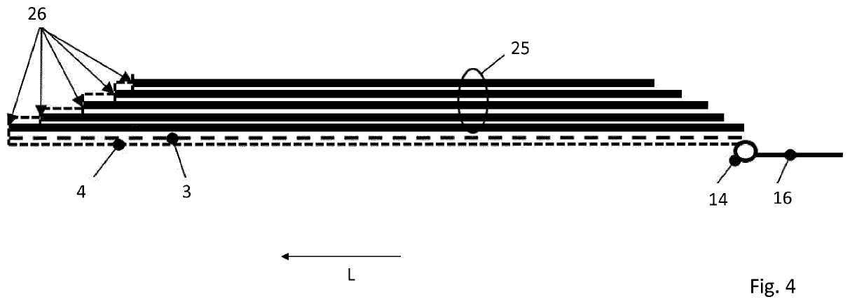

FIG. 4 shows a view of a basic construction of the longitudinal section of the CFRP girder having the protective layer and the insulation layer in a second embodiment, wherein the protective layer is electrically conductively connected to the end faces of the CFRP layers at the tip end.

FIG. 1 shows a schematic view of a part of a longitudinal section along a web 1, in particular a main web, of a rotor blade 15. The web 1 is arranged between a rotor blade surface 5 on the suction side and one on the pressure side. The rotor blade surface 5 outwardly delimits the respective rotor blade half-shell on the suction side or on the pressure side. The construction in FIG. 1 is in mirror symmetry, and layers and features on the suction side and on the pressure side are designated by the same reference.

The rotor blade half-shells consist of a laminate structure which has, on the rotor blade inner side of the rotor blade surface 5, an electrically conductive protective layer 4 which in the embodiment according to FIG. 1 contains carbon fibres or is even made completely from carbon fibres. The protective layer 4 can form the outermost layer of the rotor blade half-shell, but it is also conceivable that a glass fibre layer which protects the protective layer 4 against damage is laid externally on the protective layer 4.

In principle, according to FIG. 1 the layer structure of the rotor blade half-shells on the pressure side and on the suction side is the same. On the rotor blade inner side of the protective layer 4 an insulator layer 3 is provided which is made for example from glass fibre-reinforced plastics material. The insulator layer 3 isolates the protective layer 4 electrically from a girder 2 containing carbon fibres which is arranged on the rotor blade inner side of the insulator layer 3. The girder 2 containing carbon fibres is likewise electrically conductive and is electrically isolated from the electrically conductive protective layer 4 by the insulator layer 3. The girders 2 containing carbon fibres are also designated as CFRP girders 2.

The rotor blade is structured so that in an interior space of the rotor blade a CFRP girder 2 on the pressure side and a CFRP girder on the suction side are arranged opposite one another and the web 1 runs between the CFRP girders 2. The CFRP girders 2 in particular increase the specific strength and rigidity of the rotor blade. The web 1 absorbs the thrust forces and pressure forces which are produced during the deformation of the rotor blade under load.

In principle further layers, in particular layers containing plastic fibres, can be arranged between the protective layer 4 and the CFRP girder 2. In particular the rotor blade half-shell possibly has a plurality of woven fabric or laid fabric layers, which can additionally comprise a sandwich core material, in a longitudinal direction L alongside the CFRP girder 2 on the suction side and the CFRP girder on the pressure side. According to the invention the CFRP girders 2 on each side of the rotor blade shell are completely electrically isolated from the associated protective layer 4.

FIG. 2 shows a schematic top view of the rotor blade 15 for example according to FIG. 1. FIG. 2 shows that the girder 2 on the pressure side extends over almost the entire longitudinal extent in the longitudinal direction L of the rotor blade 15 and in a tip portion 17 and in a central rotor blade portion 18 and a central portion of the girder 2 on the rotor blade outer side is completely covered by the protective layer 4. This means in particular that the protective layer 4 covers a contour 12 of the girder 2 assigned to it. The contour 12 of the girder 2 is shown as translucent in FIG. 2. The construction applies to the suction side and the pressure side of the rotor blade 15. The protective layer 4 protects the electrically conductive CFRP girder 2 against lightning strikes which, experience shows, actually occur in particular in the tip portion 17 and along a trailing edge of the rotor blade 15. However, by comparison with electrically non-conductive girders, the CFRP girder 2 additionally attracts lightning strikes.

In addition to the protective layer 4, on the rotor blade 15 lightning receptors are usually provided, which are preferably arranged directly on the tip in the tip portion 17 and also spaced apart from one another along the trailing edge of the rotor blade 15. The lightning receptors are electrically conductively connected to a lightning conductor. The lightning receptors are not shown in FIG. 2.

However, FIG. 2 shows the lightning conductor 16, which extends over the entire longitudinal extent parallel to the girder 2 and in the region of a rotor blade root 19 is electrically conductively connected to an earth (not shown) by which a lightning strike into the rotor blade 15 is conducted away into the earth via the lightning conductor 16. Rotary feedthroughs for the lightning conductor 16 through the rotor blade connection are known in the prior art.

The lightning receptors, which are not shown, are directly connected to the lightning conductor 16. FIG. 2 shows that the protective layer 4 is electrically conductively connected to a connection point 14 in addition to the lightning conductor 16. The connection point 14 can be a copper cable which is led from the protective layer 4 to the lightning conductor 15. In principle a plurality of connection points 14 can be provided.

FIG. 3 shows the structure of the transition according to the invention from the CFRP girder 2 to the protective layer 4 in a longitudinal section. The CFRP girder 2 comprises a plurality of carbon fibre-reinforced individual layers 25. FIG. 3 shows that the CFRP girder 2 is made up of a large number of carbon fibre-reinforced individual layers 25.

During the production of the rotor blade shell the CFRP girder 2 is usually produced separately in a production mould in a lamination process. For this purpose the large number of carbon fibre-reinforced individual layers 25 are laid one on top of the other.

The rotor blade half-shell is produced in a discrete production mould provided for the rotor blade half-shell. On the rotor blade inner side the protective layer 4 is laid on an optionally provided individual glass fibre layer which in a top view according to FIG. 2 can be formed as an elongated rectangle. The protective layer 4 is laid along the production mould in the longitudinal direction L directly onto the production mould or optionally onto an additionally provided glass fibre layer, and then the insulator layer 3 is laid onto the protective layer 4 on the rotor blade inner side, said insulator layer having a width B which corresponds to at least the width of the girder 2 and at least a length of the girder 2 in the portion in which the protective layer 4 covers the girder 2. The protective layer 4 is designed to be so wide that it covers the outline of the girder 2 and to be only so long in the tip portion 17 that it projects beyond the tip end of the girder 2 and into the tip portion 17. The CFRP girder 2 is laid on the insulator layer 3.

The insulator layer 3 is preferably designed in one piece and in single-ply form. The insulator layer 3 isolates the protective layer 4 electrically from the CRFP girder 2.

The protective layer 4 protects the CFRP girder 2 against lightning strikes and in particular against strikes by smaller current flows following a main lightning pulse current. The protective layer 4 is electrically conductively connected to the lightning conductor 16 via the connection point 14 according to FIG. 3. However, since the electrically conductive CFRP girder 2 or the carbon fibre-reinforced individual layers 25 of the CFRP girder 2 can also become electrically charged, according to the invention it is provided that the CFRP girder 2 can likewise be electrically conductively connected with the aid of the protective layer 4 to the lightning conductor 16. According to the invention it is provided that, according to FIG. 3, at the root end of the individual carbon fibre-reinforced individual layers 25 of the CFRP girder 2 the carbon fibre-reinforced individual layers 25 are connected by electrically conductive connections 26 to the protective layer 4, and the protective layer 4 is connected at its root end to the lightning conductor 16 via a connection point 14, so that the CFRP girder 2 as a whole and each individual carbon fibre-reinforced individual layer 25 of the CFRP girder 2 are electrically conductively connected to the lightning conductor 16 and thus are earthed and therefore a potential equalisation takes place between the protective layer 4 and the CFRP girder 2.

In a third embodiment according to FIG. 4 the construction is initially exactly like the construction illustrated and described in FIG. 3. The explanations relating to FIG. 3 also apply here. The electrically conductive connection point 14 between the protective layer 4 and the lightning conductor 16 is provided at the root end of the protective layer 4. In the third embodiment according to FIG. 4, however, the individual carbon fibre-reinforced individual layers 25 of the CFRP girder 2 are connected not at the root end but rather at the tip end to the protective layer 4 by the electrically conductive connections 26.

### LIST OF REFERENCES

1 web
2 girder
3 insulator layer
4 protective layer
5 rotor blade surface
12 contour
14 connection point
15 rotor blade
16 lightning conductor
17 tip portion
18 rotor blade portion
19 rotor blade root
25 carbon fibre-reinforced individual layers
26 electrically conductive connections
B width
L longitudinal direction

1. Rotor blade of a wind turbine, comprising at least one girder (2), at least one protective layer (4) which is arranged on the at least one girder (2) on the rotor blade outer side, wherein the at least one protective layer (4) is designed to be electrically conductive and is connected to a lightning conductor (16), characterised by at least one electrically insulating insulator layer (3) which is arranged between the at least one protective layer (4) and the at least one girder (2).

2. Rotor blade according to claim 1, characterised in that the at least one insulator layer (3) completely covers an outline of the at least one girder (2).

3. Rotor blade according to claim 1, characterised in that the at least one girder (2) is designed to be electrically conductive.

4. Rotor blade according to claim 1, characterised in that the at least one girder (2) is a girder (2) containing carbon fibres.

5. Rotor blade according to claim 1, characterised in that an electrically conductive connection (26) is provided between the at least one girder (2) and the at least one protective layer (4) only at the tip end of the girder (2) or only at the root end of the girder (2).

6. Rotor blade according to claim 1, characterised in that the at least one girder (2) has a large number of carbon fibre-reinforced individual layers (25).

7. Rotor blade according to claim 1, characterised in that the at least one protective layer (4) is separately electrically conductively connected to the lightning conductor (16).

8. Method for producing a rotor blade of a wind turbine, the at least one protective layer (4) which is designed to be electrically conductive being arranged on at least one girder (2) on the rotor blade outer side and being connected to a lightning conductor (16), characterised in that at least an electrically insulating insulator layer (3) is arranged between the at least one protective layer (4) and the at least one girder (2).

9. Rotor blade according to claim 8, characterised in that an electrically conductive connection (26) is provided between the at least one girder (2) and the at least one protective layer (4) only at the tip end of the girder (2) or only at the root end of the girder (2).

10. Method according to claim 8, characterised in that the at least one girder (2) has a large number of carbon fibre-reinforced individual layers (25).
